(19) United States
(12) Patent Application Publication
(10) Pub. No.: US 2016/0368159 A1
(43) Pub. Date: Dec. 22, 2016

(54) BLADE HOLDER

(71) Applicant: Hubbell Incorporated, Shelton, CT (US)

(72) Inventors: Lawrence N. Brown, Ctr. Barnstead, NH (US); Mark A. Chiasson, Merrimack, NH (US); Thomas R. Faucher, Manchester, NH (US)

(21) Appl. No.: 15/255,550

(22) Filed: Sep. 2, 2016

Related U.S. Application Data
(63) Continuation of application No. 12/926,895, filed on Dec. 16, 2010, now abandoned.
(60) Provisional application No. 61/282,321, filed on Jan. 22, 2010.

(51) Int. Cl. B26D 7/26; B26D 5/12; B26D 3/16; B23D 15/14; B26D 1/08

(52) U.S. Cl. CPC B26D 7/2614; B23D 15/14; B26D 1/08; B26D 3/16; B26D 5/12

(57) ABSTRACT

A hydraulically powered cutting tool includes a blade holder for securing a piece of cutting material during the shearing process. The assembly includes a tool head having a receiving area for the blade holder. A powered actuator is attached to the tool head adjacent the receiving area for actuating a moving blade. The moving blade includes a first end attached to the powered actuator and a second end with a cutting surface facing a fixed blade. The blade holder is attached to the tool head and includes an arcuate bottom surface adjacent the receiving area at a first end and a sleeve at a second end. The fixed cutting blade is received in the sleeve and includes a cutting surface disposed facing the moving blade.

### CROSS REFERENCE TO RELATED APPLICATION

This application is a continuation of prior-filed U.S. patent application Ser. No. 12/926,895 filed Dec. 16, 2010, which claims the benefit of U.S. Provisional Application No. 61/282,321, filed Jan. 22, 2010, the contents of both are hereby incorporated by reference in its entirety.

### FIELD OF THE INVENTION

The present invention relates to a blade holder with a hydraulic self-contained cutter for cutting various types of material. The blade holder is installed in a cutting tool having a C-shaped tool head with a receiving area for the material to be cut, a power actuator, a moving blade towards and away from a fixed blade attached to the blade holder and located on the opposite side of the receiving area. The blade holder can be used with various blade profiles as a restraint for the piece of material to be cut. The moving blade has a first end attached to the power actuator such as a hydraulic powered ram and a second end adjacent the receiving area. The fixed blade has a second end facing the second end of the moving blade and a first end received in a sleeve of the blade holder. The blade holder attaches to the tool head and restrains the fixed blade.

### BACKGROUND OF THE INVENTION

Typically, the fixed blade on a hydraulic cable cutter is fastened to the end of the tool head. This sometimes causes the piece being cut to move.

Conventional fixed blades are only equipped to cut material of a specific width and shape. If a user needs to cut more than one type of material, multiple tools must be used to accommodate different types of cables, wires, etc. This is costly and cumbersome because excessive tooling must be purchased and transported.

With some designated cutters on the market, material is not sheared accurately because as one blade begins to cut the material, the force of the blade is not enough to prevent the material from rotating out of the cutter head. This results in an uneven cut across the face of the material.

A need exists for a tool configured to cut different types of material that prevents the material from rotating upon contact with a first blade.

Examples of known prior art cutting devices are disclosed in the following U.S. patents: U.S. Pat. No. 2,165,209 to Baldanza; U.S. Pat. No. 4,026,028 to Green; U.S. Pat. No. 5,775,158 to Hensley et al.; U.S. Pat. No. 6,085,422 to Hirabayashi; U.S. Pat. No. 6,792,789 to Faucher; U.S. Pat. No. 6,532,790 to Frenken; and U.S. Pat. No. 6,349,474 to Jordan.

### SUMMARY OF THE INVENTION

Accordingly, an object of the invention is to provide a self-contained tool for cutting different types of material by alternating blade profiles in a blade holder to accommodate the varying widths and properties of those materials.

Another object of the invention is to provide a hydraulic cutting tool having a tool head with a receiving area to accommodate a fixed blade secured by a blade holder at a first end and a moving blade powered by a hydraulic powered ram at a second end.

A further object of the invention is to provide a blade holder having an arcuate bottom surface disposed on the receiving area and a sleeve for receiving a fixed blade.

Still another object of the invention is to provide a hydraulic self-contained cutting tool having a blade holder with a sleeve for securing a fixed blade and a moving blade adjacent the blade holder that moves towards and away from the fixed blade to cut the material suspended therebetween.

Yet another object of the invention is to provide a hydraulic self-contained cutting tool for use on ACSR, EHS guy strand, standard guy strand, ground rod, rebar, soft steel bolts, copper, and aluminum.

A further object of the invention is to provide a blade holder with an anti-rotation feature for supporting material to be cut during the cutting process while the moving blade approaches the fixed blade for cutting the material therebetween.

Still another object of the invention is to provide a blade holder for receiving EHS guy strand, standard guy strand, ground rod, rebar, and restraining such during the cutting process.

The foregoing objects are attained by providing a hydraulic cutting tool having a tool head with a receiving area. A power actuator adjacent the receiving area is coupled to a first blade. The first blade is movable by the actuator towards and away from the receiving area. The first blade has a first end attached to the power actuator and a second end facing the receiving area. A second blade is disposed opposite the first blade and includes a first side facing the second end of the first blade. A blade holder is attached to the tool head, opposite the receiving area, and includes a sleeve for receiving the second blade.

By forming the blade holder in this manner, the blade holder can be used with specific blades to cut EHS guy strand, standard guy strand, ground rod, and rebar while restraining the material during the shearing process and reducing the stroke due to the range of the tool (i.e., up to 1.5″ cable and ⅝″ ground rod).

As used in this application, the terms “top”, “bottom”, and “side” are intended to facilitate the description of the blade holder, and are not intended to limit the description of the blade holder to any particular orientation.

Other objects, advantages, and salient features of the present invention will become apparent from the following detailed description, which, taken in conjunction with the annexed drawings, discloses a preferred embodiment of the invention.

### BRIEF DESCRIPTION OF THE DRAWINGS

Referring to the drawings which form a part of this disclosure:

FIG. 1 is an exploded, side perspective view of the cutting tool and blade holder according to an exemplary embodiment of the present invention;

FIG. 2 is a side elevational view of the assembled blade holder and tool head of FIG. 1;

FIG. 3 is a front elevational view of the assembled blade holder and tool head of FIGS. 1 and 2; and

FIG. 4 is a side elevational view, opposite that of FIG. 2, of the assembled blade holder and tool head of FIGS. 1-3.

### DETAILED DESCRIPTION OF THE INVENTION

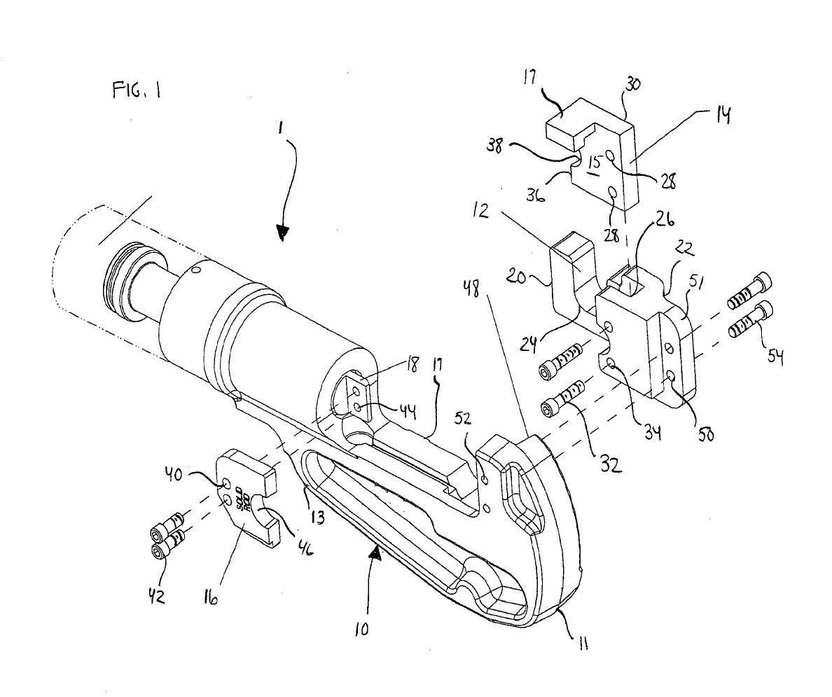

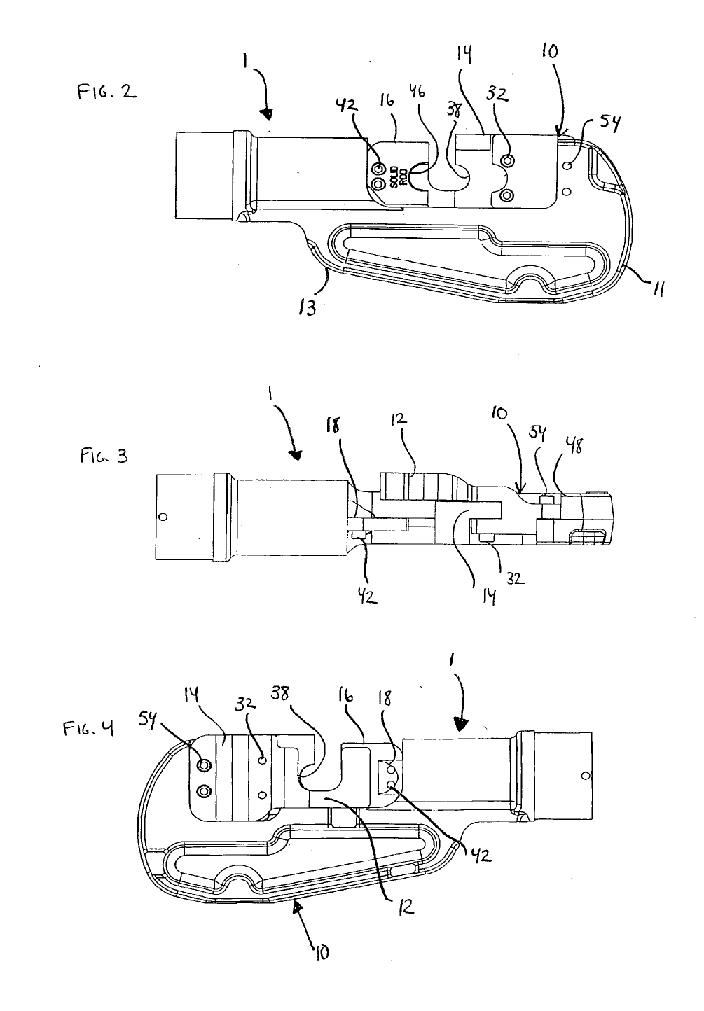

As seen in FIG. 1, a hydraulic cutting tool 1 includes a generally C-shaped tool head 10 with a blade holder 12 attached thereto. The tool head 10 includes a first end 11 adjacent the blade holder 12 and an opposing second end 13 adjacent a power actuator, such as a hydraulically powered ram 18. A receiving area 17 for the blade holder 12 extends along the longitudinal axis of the cutting tool 1 between the first end 11 and the second end 13. A fixed blade 14 is attached to the blade holder 12 adjacent the first end 11. A moving blade 16 is attached to the hydraulically powered ram 18 adjacent the second end 13. The hydraulically powered ram 18 attached to the tool head 10 forces the moving blade 16 towards and away from the fixed blade 14.

The blade holder 12 is attached to the first end 11 and restrains various types of materials to be cut by the hydraulically cutting tool 1. The blade holder 12 includes a first end 20 and a second end 22. The first end 20 is defined by an arcuately shaped bottom surface or bed 24 for receiving the cut material. The second end 22 is defined by a longitudinal sleeve 26 having three walls substantially perpendicular to the bottom surface 24 and shaped to receive the fixed cutting blade 14.

The blade holder 12 further includes a wing 51 with circular unthreaded openings 50 at the second end 22 of the blade holder 12 that align with openings 52 adjacent the receiving area 17 of the tool head 10 to fasten the blade holder 12 to the tool head 10. With this configuration, the second end 22 is fixed to mounting area 48 of the tool head 10 and the first end 20 is positioned adjacent the receiving area 17 of the tool head 10.

The plurality of screws 54 in the cutting tool 1 are externally threaded to mate with each of the corresponding internally threaded openings 52.

The fixed cutting blade 14 includes a main body 15 that is substantially a parallelepiped and a ledge portion 17 offset to one side of and at a substantially 90° angle to the top of the main body 15. The fixed blade 14 includes first and second circular openings 28 along a first end 30 received in the sleeve 26. Attachment means, such as screws 32, secure the fixed cutting blade 14 to the longitudinal sleeve 26. The screws 32 are received in and extend through top and bottom unthreaded openings 34 along the outer surface of the sleeve 26 and then threaded through first and second openings 28 of the fixed blade 14. The fixed cutting blade 14 includes a second end 36 adjacent the receiving area 17 having an arcuately shaped cutting surface 38 facing the moving blade 16 to shear the cutting material.

The moving blade 16 includes a first end attached to the hydraulically powered ram 18 with screws 42 passing through unthreaded openings 40 at the exterior end and threaded in internally threaded openings 44 in the powered ram 18. The interior end of the moving blade 16 is disposed towards the fixed cutting blade 14 and includes an arcuately shaped cutting surface 46 for shearing the cut material.

### Operation

With this configuration, the blade holder 12 is attached to the tool head 10 and prevents the fixed blade 14 from moving. The blade holder 12 stabilizes the material to be cut as the moving blade 16 shears the material. Specifically, the hydraulically powered ram 18 activates the moving blade 16 towards and away from the fixed blade 14 for shearing the material to be cut. When the shearing force is initiated, the blade holder 12 prevents the cut material from rotating out of position. The material is sheared between the cutting edge 38 of the fixed blade 14 and the cutting edge 46 of the moving blade 16. Thus, as the moving blade 16 moves towards the fixed blade 14, the material suspended in the bed 24 of the blade holder 12 is cut.

The blade holder 12 is used with a plurality of blade profiles depending on the type of material to be cut. If the cutting material is ground rod, rebar, or guy wire, the fixed blades for cutting these materials require the blade holder 12.

If the material to be cut is something other than ground rod, rebar, and guy wire, including, but not limited to, copper, aluminum, and ACSR, the blade holder 12 is eliminated and an appropriate corresponding cutting blade is attached to the mounting area 48 with screws threaded through the tool head openings 52.

While one embodiment has been chosen to illustrate the invention, it will be understood by those skilled in the art that various changes and modifications can be made therein without departing from the scope of the invention as defined in the appended claims.

What is claimed is:

1. A hydraulic cutting tool, the assembly comprising:
a tool head having a receiving area;
a power actuator adjacent said receiving area coupled to a first blade, said first blade being movable by said actuator towards and away from said receiving area, said first blade having a first end attached to said power actuator and a second end facing said receiving area;
a second blade disposed opposite said first blade having a first side facing said second end of said first blade; and
a blade holder attached to said tool head and disposed opposite said receiving area and including a sleeve for receiving said second blade.

2. A hydraulic cutting tool according to claim 1, wherein
said receiving area is adjacent said first and second blades.

3. A hydraulic cutting tool according to claim 1, wherein
said power actuator is a hydraulic powered ram.

4. A hydraulic cutting tool according to claim 1, wherein
said blade holder has an arcuate bottom surface disposed on said receiving area.

5. A hydraulic cutting tool according to claim 1, wherein
said second blade is fixed and said first blade is movable towards and away from said second blade to cut a material therebetween.

6. A hydraulic cutting tool according to claim 1, wherein
said second blade further includes a first end having a cutting surface facing said second blade and a second end opposite said first end and received in said sleeve.

7. A hydraulic cutting tool, the assembly comprising:
a tool head having a receiving area;
a power actuator attached to said tool head and coupled to a first blade for moving said first blade;
said first blade having first and second ends with said first end attached to said power actuator and said second end including a cutting surface;
a blade holder attached to said tool head having a sleeve adjacent an arcuate bottom surface for receiving a second blade; and
said second blade having first and second sides with said first side being received in said sleeve and said second side including a fixed surface facing said cutting surface.

8. A hydraulic cutting tool according to claim 7, wherein
said first blade is movable towards and away from said second blade.

9. A hydraulic cutting tool comprising:
a tool head with a restraining area for material to be cut;
a blade holder coupled to said tool head and having first and second ends with said first end including an arcuate bottom surface for positioning the material to be cut and said second end including a sleeve receiving a first blade;
a cutting surface disposed on a face of said first blade and positioned opposite a second blade; and
a hydraulic powered ram attached to said tool head and said first blade for actuating said second blade.

10. A hydraulic cutting tool according to claim 9, wherein
said tool head is C-shaped.

11. A hydraulic cutting tool according to claim 9, wherein
said first blade is fixed.

12. A hydraulic cutting tool according to claim 9, wherein
said second blade is movable.

13. A hydraulic cutting tool according to claim 12, wherein
said second blade moves towards and away from said fixed blade.

14. A hydraulic cutting tool according to claim 11, wherein
said first blade further includes a first end having a cutting surface facing said second blade and a second end opposite said first end and received in said sleeve.
